(19) United States
(12) Patent Application Publication
(10) Pub. No.: US 2018/0109349 A1
(43) Pub. Date: Apr. 19, 2018

(54) MANAGEMENT DEVICE AND WAVELENGTH SETTING METHOD

(71) Applicant: FUJITSU LIMITED, Kawasaki-shi (JP)

(72) Inventor: Toshiki Honda, Kawasaki (JP)

(73) Assignee: FUJITSU LIMITED, Kawasaki-shi (JP)

(21) Appl. No.: 15/716,741

(22) Filed: Sep. 27, 2017

(30) Foreign Application Priority Data
Oct. 13, 2016 (JP) 2016-201878

(51) Int. Cl. H04J 14/02; H04B 10/29

(52) U.S. Cl. CPC H04J 14/0227; H04J 14/0212; H04B 10/29

(57) ABSTRACT

There is provided a management device configured to manage a plurality of optical nodes in an optical transmission system, the management device including a memory, and a processor coupled to the memory and the processor configured to specify a relay node on a path relaying a traffic in the optical transmission system among the plurality of optical nodes, designate a candidate wavelength of a candidate for a target of transmitting through the traffic in the specified relay node from wavelengths being used in the specified relay node, determine whether or not the designated candidate wavelength is usable in an optical node of the plurality of optical nodes to terminate the traffic, and set the candidate wavelength in the relay node, as a wavelength used to transmit through the traffic, when it is determined that the designated candidate wavelength is usable in the optical node to terminate the traffic.

### CROSS-REFERENCE TO RELATED APPLICATION

This application is based upon and claims the benefit of priority of the prior Japanese Patent Application No. 2016-201878, filed on Oct. 13, 2016, the entire contents of which are incorporated herein by reference.

### FIELD

The embodiments discussed herein are related to a management device and a wavelength setting method.

### BACKGROUND

In recent years, a WDM transmission system using wavelength division multiplexing (WDM) that, for example, multiplexes and transmits optical signals having different wavelengths has been distributed. In the WDM transmission system, a plurality of ROADMs (Reconfigurable Optical Add Drop Multiplexer) is connected by optical fibers. ROADM is an optical add drop multiplexer (OADM) that can branch an optical signal having a desired wavelength from a WDM signal and insert an optical signal into an empty channel of the WDM signal.

Since an optical path is fixed for each wavelength, ROADM may not perform wavelength change or path change by remote operation. Therefore, workers have to be dispatched to office buildings to work for wavelength change and path change, imposing a big burden on the workers. Therefore, for example, CD (Colorless Directionless)-ROADM, CDC (Colorless Directionless Contention less)-ROADM and the like have appeared as the next generation ROADM which enables wavelength change and path change by remote operation. “Colorless” means that a wavelength may be changed without changing the connection with an optical fiber from a remote place. “Directionless” means that a direction may be changed without changing the connection with an optical fiber from a remote place. Further, “Contention less” means to avoid wavelength contention.

In a CD-ROADM including optical components such as optical couplers and optical splitters, optical signals having the same wavelength may not be optically branched/inserted from/in the same optical coupler and optical splitter due to the properties of the optical components, causing a contention where wavelengths collide with each other. Consequently, avoidance of contention acts as a restriction on optical line design of an optical transmission system formed with a plurality of CD-ROADMs.

Related technologies are disclosed in, for example, Japanese Laid-Open Patent Publication Nos. 2012-060622, 2014-022865, and 2014-107709.

### SUMMARY

According to an aspect of the invention, a management device is configured to manage a plurality of optical nodes in an optical transmission system, the management device includes a memory, and a processor coupled to the memory and the processor configured to specify a relay node on a path relaying a traffic in the optical transmission system among the plurality of optical nodes, designate a candidate wavelength of a candidate for a target of transmitting through the traffic in the specified relay node from wavelengths being used in the specified relay node, determine whether or not the designated candidate wavelength is usable in an optical node of the plurality of optical nodes to terminate the traffic, and set the candidate wavelength in the relay node, as a wavelength used to transmit through the traffic, when it is determined that the designated candidate wavelength is usable in the optical node to terminate the traffic.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of an optical transmission system according to a first embodiment;

FIG. 2 is an explanatory view illustrating an exemplary hardware configuration of CD-ROADM;

FIG. 3 is an explanatory view illustrating an exemplary functional configuration of an SDN controller according to the first embodiment;

FIG. 4 is an explanatory view illustrating an example of wavelength usage for each direction of CD-ROADM;

FIG. 5 is an explanatory view illustrating an example of a direction wavelength DB;

FIG. 6 is an explanatory view illustrating an example of a candidate wavelength memory;

FIG. 7 is a flowchart illustrating an example of a processing operation of CPU related to a first setting process;

FIG. 8 is a flowchart illustrating an example of a processing operation of CPU related to a first determination process;

FIG. 9 is an explanatory view illustrating an exemplary functional configuration of an SDN controller according to a second embodiment;

FIG. 10 is an explanatory view illustrating an example of predetermined conditions;

FIG. 11 is a flowchart illustrating an example of a processing operation of CPU related to a second setting process;

FIG. 12 is an explanatory view illustrating an exemplary functional configuration of an SDN controller according to a third embodiment;

FIG. 13 is an explanatory view illustrating an example of a coupler wavelength DB;

FIG. 14 is an explanatory view illustrating an example of a priority wavelength memory;

FIG. 15 is a flowchart illustrating an example of a processing operation of CPU related to a second determination process;

FIG. 16 is an explanatory view illustrating an example of another CD-ROADM;

FIG. 17A is an explanatory view illustrating an example of a wavelength allocation method of an optical transmission system according to another embodiment; and

FIG. 17B is an explanatory view illustrating an example of a wavelength allocation method of an optical transmission system according to still another embodiment.

### DESCRIPTION OF EMBODIMENTS

In an optical transmission system having a plurality of CD-ROADMs, for example, contention may be avoided by sequentially allocating empty wavelengths for each traffic in the order of occurrence of traffic. However, in the optical transmission system, when empty wavelengths are sequentially allocated in the order of occurrence of traffic, although contention may be avoided, wavelength fragmentation occurs, which lowers the utilization efficiency of wavelength resources. Moreover, in a complicated optical transmission system such as a mesh configuration, the wavelength fragmentation partially occurs and the number of wavelengths to be allocated to signals transmitted over a plurality of spans becomes extremely small, which remarkably lowers the utilization efficiency of wavelength resources.

Embodiments of a technique capable of improvement of the utilization efficiency of wavelength resources will be described in detail below with reference to the drawings. Incidentally, the disclosed technology is not limited by these embodiments. In addition, the following embodiments may be used in proper combination unless contradictory.

### First Embodiment

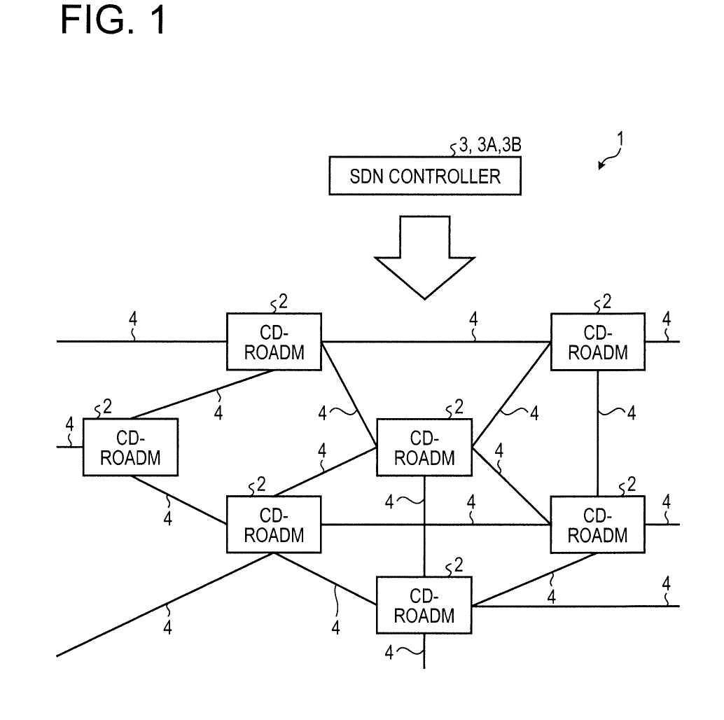

FIG. 1 is an explanatory view illustrating an example of an optical transmission system 1 according to a first embodiment. As illustrated in FIG. 1, the optical transmission system 1 includes a plurality of CD-ROADMs 2 and a software defined network (SDN) controller 3. Each CD-ROADM 2 is an optical add/drop device such as a Wavelength Division Multiplexing (WDM) transmission device that multiplexes and transmits a plurality of optical signals having different wavelengths. The CD-ROADM 2 is an optical add/drop device which is connected to another CD-ROADM 2 through an optical fiber 4 and optically inserts (adds) and branches (drops) optical signals having different wavelengths. The SDN controller 3 monitors and controls the entire optical transmission system 1. For example, the optical transmission system 1 has a mesh configuration in which the plurality of CD-ROADMs 2 are connected to each other in a mesh form by optical fibers 4.

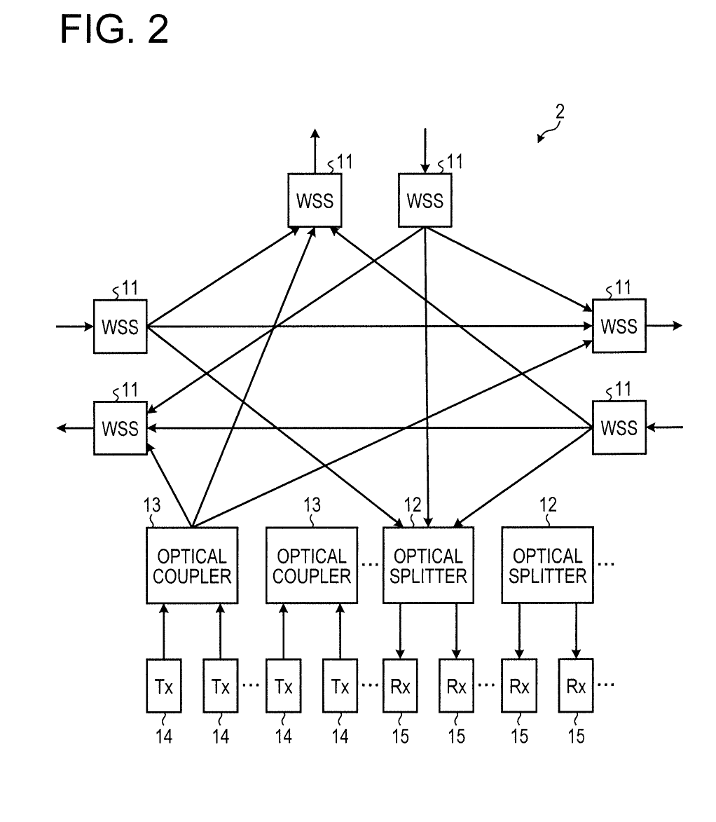

FIG. 2 is an explanatory view illustrating an exemplary hardware configuration of the CD-ROADM 2. As illustrated in FIG. 2, the CD-ROADM 2 includes a plurality of Wavelength Selective Switches (WSSs) 11, a plurality of optical splitters 12, a plurality of optical couplers 13, a plurality of transmitters (Txs) 14 and a plurality of receivers (Rxs) 15. A WSS 11 is a switch for switching and selecting an optical signal on a wavelength basis. The WSS 11 has, for example, input ports having the number that is equal to one input port×N output ports. An optical coupler 13 is an optical insertion unit that optically inserts an optical signal on a wavelength basis. An optical splitter 12 is an optical branching unit that optically branches an optical signal on a wavelength basis. A transmitter 14 is a line card that transmits an optical signal. A receiver 15 is a line card that receives an optical signal.

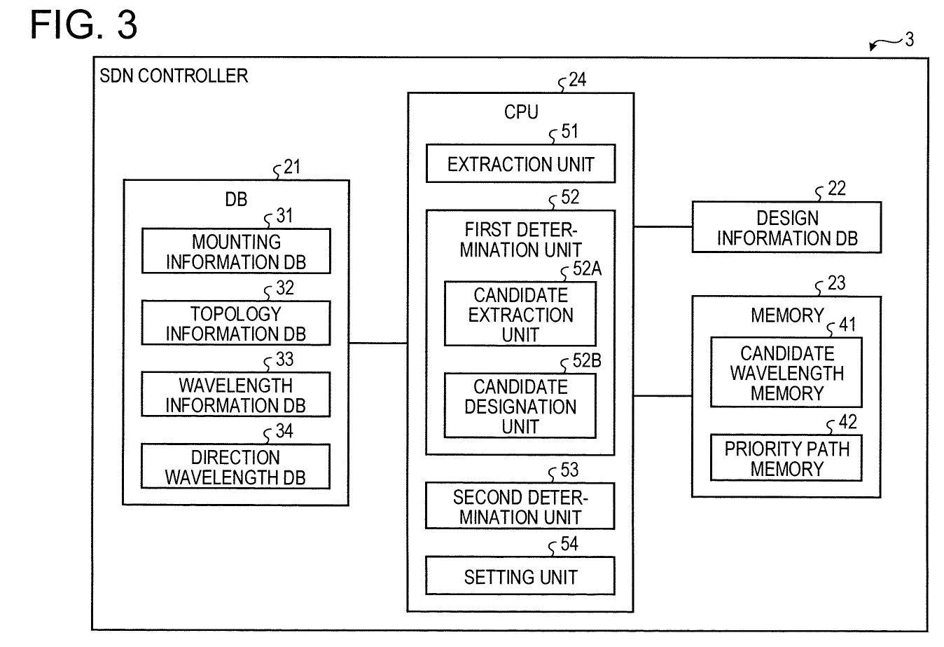

FIG. 3 is an explanatory view illustrating an exemplary functional configuration of the SDN controller 3 according to the first embodiment. As illustrated in FIG. 3, the SDN controller 3 includes a database (DB) 21, a design information DB 22, a memory 23, and a CPU 24. The DB 21 includes a mounting information DB 31, a topology information DB 32, a wavelength information DB 33, and a direction wavelength DB 34. The mounting information DB 31 is a DB for managing mounting information of optical components such as the WSSs 11, the optical splitters 12, the optical couplers 13, the transmitters 14, and the receivers 15 in the CD-ROADMs 2. The mounting information is a variety of specification information such as the number of ports and an allowable wavelength of an optical component. The topology information DB 32 is a DB that manages connection information such as a path configuration that is the connection status of each WSS 11, optical splitter 12, optical coupler 13, transmitter 14, and receiver 15. The wavelength information DB 33 is a DB for managing the wavelength use situation of each WSS 11, optical splitter 12, optical coupler 13, transmitter 14, and receiver 15, and path. The direction wavelength DB 34 is a DB that manages a wavelength being used for each direction in the CD-ROADM 2. The design information DB 22 is a DB that manages the design contents of the optical transmission system 1, for example, the transmission propriety for each path.

The memory 23 is an area that stores various kinds of information. The memory 23 includes a candidate wavelength memory 41 and a priority path memory 42. The candidate wavelength memory 41 is an area that stores through-target candidate wavelengths in the CD-ROADM 2 on a path connecting start and end points of a new traffic. A through-target candidate wavelength is a wavelength of a new traffic that may pass through a relay CD-ROADM 2 on a path connecting start and end points of the new traffic. The priority path memory 42 is an area for storing candidate paths according to a priority. A candidate path is an allocable path of a new traffic that connects start and end points of the new traffic.

The CPU 24 includes an extraction unit 51, a first determination unit 52, a second determination unit 53, and a setting unit 54. The extraction unit 51 refers to the design information DB 22 to extract a candidate path connecting the start point and end point of a traffic according to a selection criterion. The selection criterion is, for example, the descending order of transmission distance but may be costs, the descending order of the number of relay nodes or spans, or the increasing order of utilization. After extracting the candidate path, the extraction unit 51 designates the candidate path and refers to the design information DB 22 to determine whether or not the designated candidate path may be transmitted. When the designated candidate path may be transmitted, the extraction unit 51 stores the candidate path in the priority path memory 42 according to a priority of the selection criterion. Incidentally, it is assumed that the priority path memory 42 stores, for example, up to five candidate paths with high selection criteria.

The first determination unit 52 designates a wavelength of a candidate for a target of transmitting through (through-target candidate wavelength) in a relay CD-ROADM 2 on a candidate path connecting the start and end points of a new traffic. The first determination unit 52 includes a candidate extraction unit 52A and a candidate designation unit 52B. The candidate extraction unit 52A extracts a wavelength being used for each direction in the relay CD-ROADM 2 and stores the extracted wavelength being used in the direction wavelength DB 34 for each direction. Further, the candidate extraction unit 52A refers to the direction wavelength DB 34 to extract a usable wavelength as a candidate wavelength for each through-direction in the relay CD-ROADM 2. Incidentally, a through-direction is, for example, a path for transmitting an optical signal between directions in the CD-ROADM 2. In the CD-ROADM 2, the same wavelength may not be optically branched and inserted in the same optical component such as the optical splitter 12 or the optical coupler 13, but it is possible to use a wavelength used for the optical branching and insertion to pass through the same optical component. Then, the candidate extraction unit 52A stores the extracted wavelength for each through-direction in the candidate wavelength memory 41. The candidate designation unit 52B designates a candidate wavelength for each through-direction corresponding to a candidate path in the candidate wavelength memory 41. In addition, the candidate designation unit 52B designates, for example, a shortest candidate wavelength among candidate wavelengths for each through-direction corresponding to the candidate path.

The second determination unit 53 refers to the wavelength information DB 33 to determine whether or not a designated candidate wavelength is a wavelength that is usable in the CD-ROADM 2 at a traffic start/end point. When the designated candidate wavelength is the usable wavelength in the CD-ROADM 2 at the traffic start/end point, the second determination unit 53 determines the candidate wavelength as an allocated wavelength to for each traffic. When the designated candidate wavelength is not the usable wavelength in the CD-ROADM 2 at the traffic start/end point, the second determination unit 53 instructs the first determination unit 53 to designate a separate candidate wavelength among the plurality of candidate wavelengths. When it is determined in the second determination unit 53 that the designated candidate wavelength is the usable wavelength in the CD-ROADM 2 at the traffic start/end point, the setting unit 54 sets the candidate wavelength and the candidate path, as an allocated wavelength and an allocated path for each traffic, respectively, in the relay CD-ROADM 2. For example, the setting unit 54 sets a traffic allocated wavelength in a transmitter 14 and a receiver 15 and also in a WSS 11.

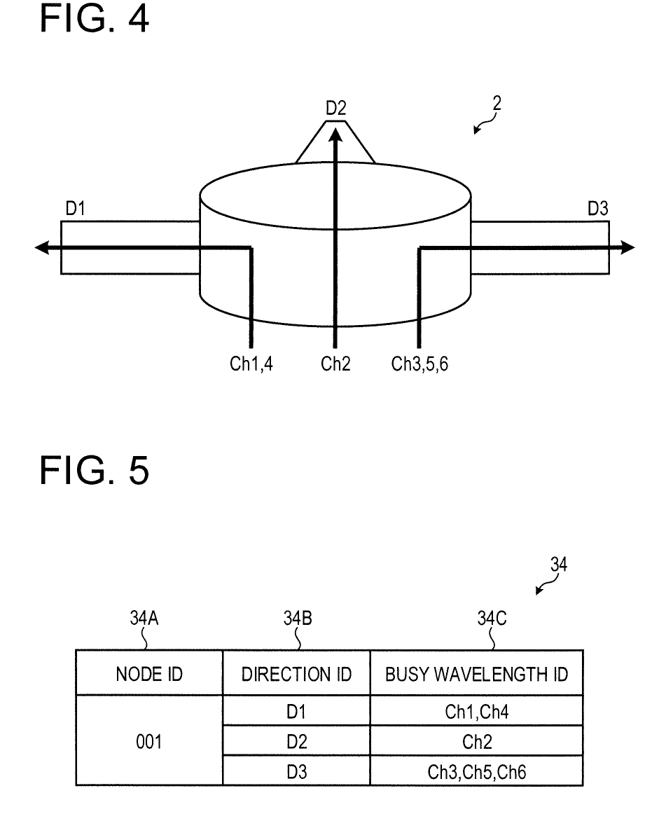

FIG. 4 is an explanatory view illustrating an example of wavelength usage for each direction of the CD-ROADM 2. The CD-ROADM 2 illustrated in FIG. 4 has, for example, three directions, i.e., a direction D1 set with wavelengths Ch1 and Ch4, a direction D2 set with a wavelength Ch2, and a direction D3 set with wavelengths Ch3, Ch5, and Ch6. FIG. 5 is an explanatory view illustrating an example of the direction wavelength DB 34. The direction wavelength DB 34 illustrated in FIG. 5 manages a node ID 34A, a direction ID 34B, and a wavelength being used ID 34C in association. The wavelength being used ID is described at the following as busy wavelength ID. The node ID 34A is an ID for identifying a relay CD-ROADM 2. The direction ID 34B is an ID for identifying a direction within the relay CD-ROADM 2. The busy wavelength ID 34C is an ID for identifying a wavelength being used in the direction in the relay CD-ROADM 2. The direction wavelength DB34 illustrated in FIG. 5 manages, for example, wavelengths Ch1 and Ch4 as wavelengths being used of a direction D1, a wavelength Ch2 as a wavelength being used of a direction D2, and wavelengths Ch3, Ch5, and Ch6 as wavelengths being used of a direction D3.

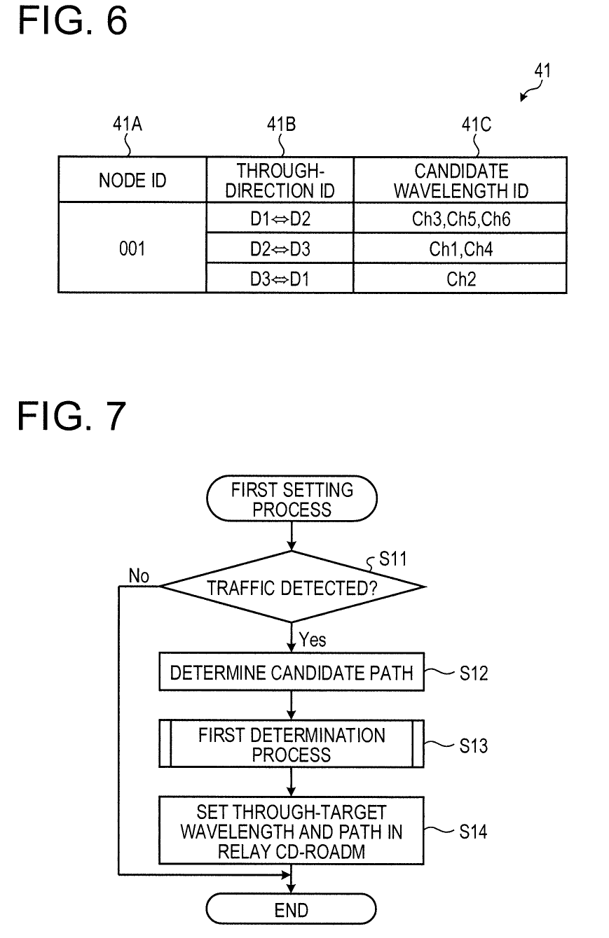

FIG. 6 is an explanatory view illustrating an example of the candidate wavelength memory 41. The candidate wavelength memory 41 illustrated in FIG. 6 manages a node ID 41A, a through-direction ID 41B and a candidate wavelength ID 41C in association. The node ID 41A is an ID for identifying a relay CD-ROADM 2. The through-direction ID 41B is an ID for identifying the through-direction between directions in the relay CD-ROADM 2. Incidentally, a through-direction refers to a transmittable path between the direction D1 and the direction D2, between the direction D2 and the direction D3, and between the direction D3 and the direction D1, as an example in FIG. 6. The candidate wavelength ID 41C is an ID for identifying a candidate wavelength that is usable in a through-direction in the relay CD-ROADM 2. The candidate wavelength memory 41 illustrated in FIG. 6 manages wavelengths Ch3, Ch5, and Ch6 as candidate wavelengths between the direction D1 and the direction D2, wavelengths Ch1 and Ch4 as candidate wavelengths between the direction D2 and the direction D3 and a wavelength Ch2 as a candidate wavelength between the direction D3 and the direction D1.

Next, the operation of the optical transmission system 1 according to the first embodiment will be described. FIG. 7 is a flowchart illustrating an example of the processing operation of the CPU 24 related to the first setting process. The CPU 24 that executes the first setting process shown in FIG. 7 determines whether a new traffic is detected in the optical transmission system 1 (Operation S11). When it is determined that a new traffic is detected (“Yes” in Operation S11), the CPU 24 determines a candidate path corresponding to the new traffic (Operation S12). Incidentally, the candidate path is, for example, the highest-level candidate path in the priority path memory 42.

After determining the candidate path, the CPU 24 executes the first determination process on the candidate path (Operation S13). After executing the first determination process, the CPU 24 sets a through-target wavelength and direction in a relay CD-ROADM 2 on the candidate path (Operation S14) and ends the processing operation illustrated in FIG. 7. When it is determined that no new traffic is detected (“No” in Operation S11), the CPU 24 ends the processing operation shown in FIG. 7.

When a new traffic is detected, the CPU 24 executing the first setting process sets a through-target wavelength and direction of the relay CD-ROADM 2 on the candidate path connecting the start and end points of the new traffic. As a result, it is possible to arrange an optimal optical path for the new traffic.

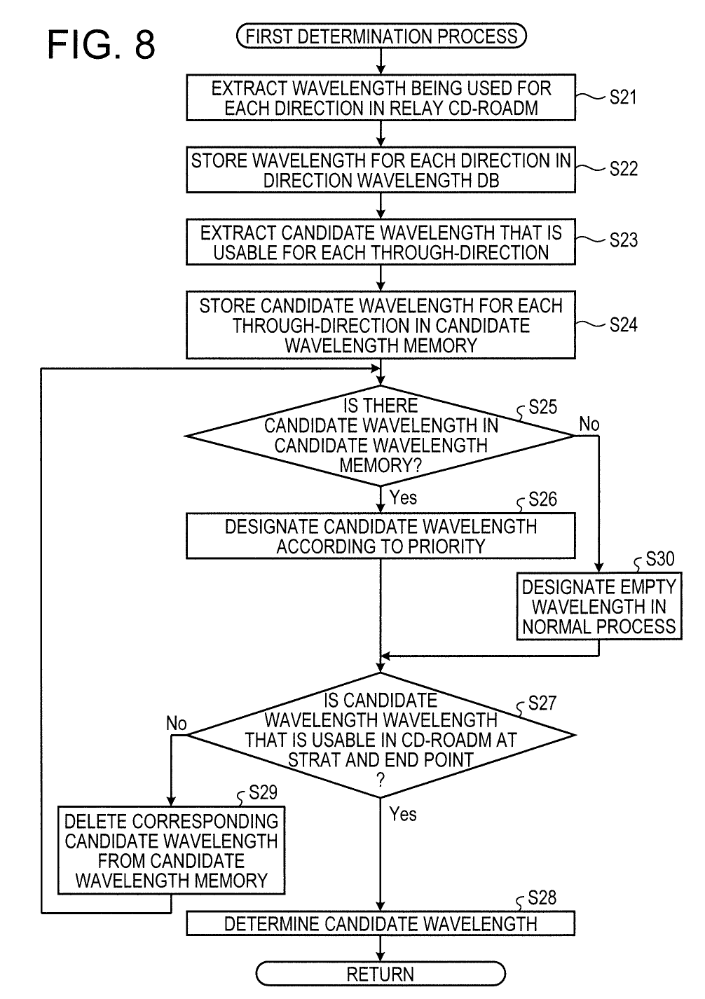

FIG. 8 is a flowchart illustrating an example of the processing operation of the CPU 24 related to the first determination process. In FIG. 8, the candidate extraction unit 52A in the CPU 24 extracts a wavelength being used for each direction in the relay CD-ROADM 2 (Operation S21). Incidentally, the wavelength being used is a wavelength being used in a direction in the relay CD-ROADM 2. The candidate extraction unit 52A stores the extracted wavelength being used for each direction in the direction wavelength DB 34 (Operation S22). The candidate extraction unit 52A refers to the direction wavelength DB 34 to extract a candidate wavelength that is usable for each through-direction in the relay CD-ROADM 2 based on the wavelength being used for each direction in the relay CD-ROADM 2 (Operation S23). Incidentally, the candidate wavelength is a wavelength that is usable for a through-direction. The candidate extraction unit 52A stores the extracted candidate wavelength for each through-direction in the candidate wavelength memory 41 (Operation S24).

After the extracted candidate wavelength is stored in the candidate wavelength memory 41, the candidate designation unit 52B in the CPU 24 determines whether or not there is a candidate wavelength in the candidate wavelength memory 41 (Operation S25). When it is determined that there is a candidate wavelength in the candidate wavelength memory 41 (“Yes” in Operation S25), the candidate designation unit 52B designates the candidate wavelength according to a priority (Operation S26). Incidentally, the priority is, for example, the order of designating a shorter candidate wavelength preferentially.

The candidate designation unit 52B refers to the wavelength information DB 33 to determine whether or not the designated candidate wavelength is a wavelength that is usable in the CD-ROADM 2 at the traffic start and end points (Operation S27). When it is determined that the designated candidate wavelength is a wavelength that is usable in the CD-ROADM 2 at the traffic start and end points (“Yes” in Operation S27), the candidate designation unit 52B determines the candidate wavelength as an allocated wavelength (Operation S28) and ends the processing operation shown in FIG. 8.

When it is determined that the candidate wavelength is not a wavelength that is usable in the CD-ROADM 2 at the traffic start and end points (“No” in Operation S27), the candidate extraction unit 52A deletes the designated candidate wavelength from the candidate wavelength memory 41 (Operation S29). Then, the candidate designation unit 52B proceeds to Operation S to determine whether or not there is a candidate wavelength in the candidate wavelength memory 41. After the designated candidate wavelength is deleted from the candidate wavelength memory 41, when it is determined in Operation S25 that there is a candidate wavelength in the candidate wavelength memory 41, the candidate designation unit 52B proceeds to Operation S26 to designate a separate candidate wavelength from the candidate wavelength memory 41 according to a priority. When it is determined that there is no candidate wavelength in the candidate wavelength memory 41 (“No” in Operation S25), the candidate designation unit 52B executes a normal process of designating an empty wavelength (Operation S30). In the normal processing, for example, the shortest wavelength among empty wavelengths other than the candidate wavelengths stored in the candidate wavelength memory 41 is designated. Then, the candidate designation unit 52B proceeds to Operation S27 to determine whether or not the designated candidate wavelength is a wavelength that is usable in the CD-ROADM 2 at the traffic start and end points.

The CPU 24 that executes the first determination process illustrated in FIG. 8 stores in the candidate wavelength memory 41 a candidate wavelength for each through-direction in the relay CD-ROADM 2 on a candidate path of a new traffic. The CPU 24 refers to the candidate wavelength memory 41 to designate a candidate wavelength of the through-direction corresponding to the candidate path according to a priority. When the designated candidate wavelength is a wavelength that is usable in the CD-ROADM 2 at the traffic start and end points, the CPU 24 determines the candidate wavelength as a through-target wavelength. As a result, the CPU 24 can determine an optimal through-target allocated wavelength and allocated path to be used for a new traffic by remote operation. Furthermore, the CPU 24 can reduce the chance of irregular wavelength placement due to contention avoidance while reducing the number of wavelengths to be contended, and may suppress wavelength fragmentation, thereby achieving the high utilization efficiency of wavelength resources.

The CPU 24 of the first embodiment refers to the candidate wavelength memory 41 to designate a candidate wavelength of a through-direction corresponding to a candidate path of a new traffic according to a priority. Further, when the designated candidate wavelength is a wavelength that is usable in the CD-ROADM 2 at the traffic start and end points, the CPU 24 determines the candidate wavelength as a through-target wavelength. As a result, the CPU 24 can determine an optimal through-target allocated wavelength and allocated path to be used for the new traffic by remote operation.

The CPU 24 of the first embodiment specifies a relay CD-ROADM 2 on a path relaying a generated traffic among a plurality of CD-ROADMs 2 and designates a transmittable candidate wavelength from wavelengths being used for each direction in the specified relay CD-ROADM 2. When the designated candidate wavelength is a wavelength that is usable in the CD-ROADM 2 at the traffic start and end points, the CPU 24 sets the candidate wavelength in the relay CD-ROADM 2 as a wavelength that transmits the traffic. As a result, it is possible to reduce the chance of irregular wavelength placement due to contention avoidance while reducing the number of wavelengths to be contended and suppress wavelength fragmentation, thereby achieving the high utilization efficiency of wavelength resources. Then, the SDN controller 3 can provide an optical transmission system 1 of a CD-ROADM 2 compatible with contention-less and direction-less. Furthermore, it is possible to achieve network operation by the CD-ROADM 2 with low costs and high flexibility.

The CPU 24 stores in the candidate wavelength memory 41 a candidate wavelength that is usable for each through-direction in the relay CD-ROADM 2 from wavelengths being used for each direction in the relay CD-ROADM 2. As a result, the CPU 24 can refer to the candidate wavelength memory 41 to simply designate a through-target candidate wavelength in the relay CD-ROADM 2.

In Operation S26 shown in FIG. 8, a candidate wavelength is designated in the order of shorter wavelengths according to a priority of the shortest wavelengths, but this designation is not limited to the priority of the shortest wavelengths and may be appropriately changed. For example, a candidate wavelength may be designated in order of longer wavelengths according to a priority of the longest wavelengths.

The CPU 24 of the first embodiment designates the single highest-level candidate path and then designates a candidate wavelength of a through-direction of the relay CD-ROADM 2 on the designated candidate path. However, without being limited to the single candidate path, the CPU 24 may sequentially designate a plurality of candidate paths in the priority path memory 42, which will be described below as a second embodiment.

### Second Embodiment

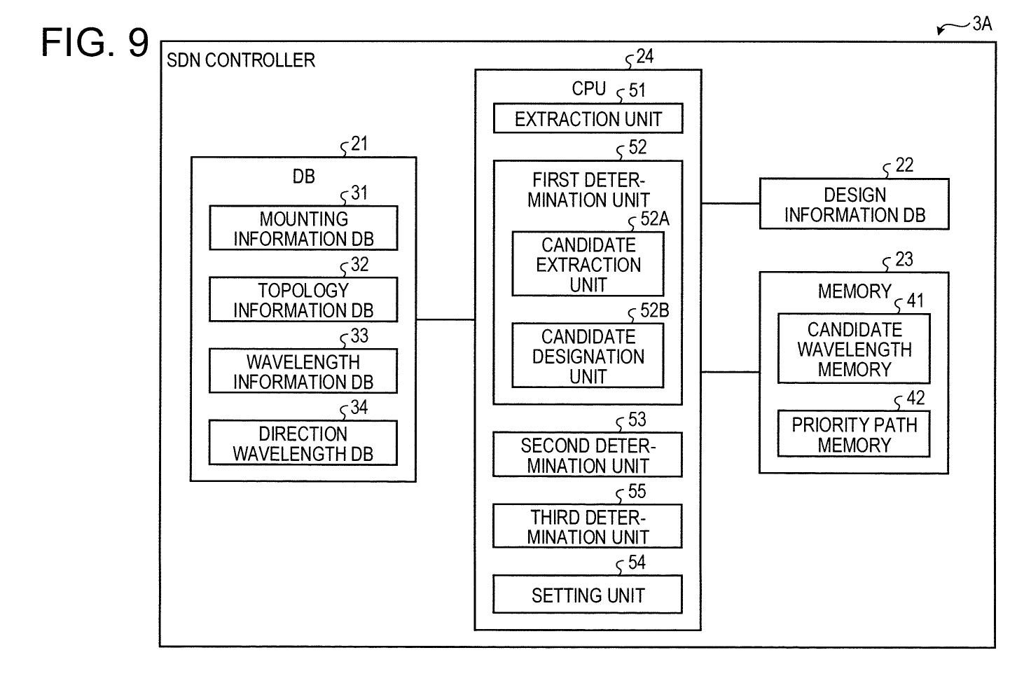

FIG. 9 is an explanatory view illustrating an exemplary functional configuration of a SDN controller 3A according to a second embodiment. In FIG. 9, the same elements and operations as those of the optical transmission system 1 of the first embodiment are denoted by the same reference numerals and therefore, explanation of which will not be repeated. The CPU 24 in the SDN controller 3A includes a third determination unit 55 in addition to the extraction unit 51, the first determination unit 52, the second determination unit 53, and the setting unit 54. The third determination unit 55 determines whether or not a candidate wavelength satisfies a predetermined condition. The predetermined condition used herein is that a candidate wavelength is a wavelength being used in all relay CD-ROADMs 2 on a path connecting the traffic start and end points. When a candidate wavelength satisfies the predetermined condition, the setting unit 54 sets the candidate wavelength and the candidate path as through-target allocated wavelength and allocated path related to the traffic, respectively. When the candidate wavelength does not satisfy the predetermined condition, the third determination unit 55 deletes the candidate path whose candidate wavelength does not satisfy the predetermined condition from the priority path memory 42 so as to designate another candidate path. The first determination unit 52 designates a candidate path for a new traffic from the priority path memory 42. After designating the candidate path, the first determination unit 52 designates a candidate wavelength for each through-direction corresponding to the candidate path.

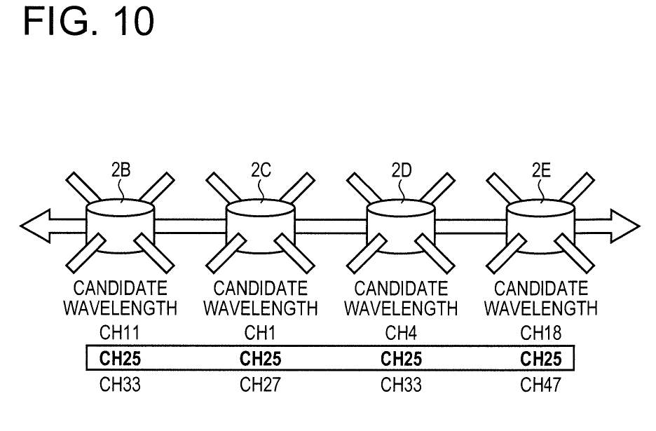

FIG. 10 is an explanatory view illustrating an example of the predetermined condition. In the example of FIG. 10, the predetermined condition is that a candidate wavelength is a wavelength being used by all relay CD-ROADMs 2 on a path connecting the traffic start and end points. It is here assumed that wavelengths being used of a relay CD-ROADM 2B on the path connecting the traffic start and end points are Ch11, Ch25, and Ch33, wavelengths being used of a relay CD-ROADM 2C are Ch1, Ch25, and Ch27, wavelengths being used of a relay CD-ROADM 2D are Ch4, Ch25, and Ch33, and wavelengths being used of a relay CD-ROADM 2E are Ch18, Ch25, and Ch47. In this case, a candidate wavelength that satisfies the predetermined condition is Ch25 being used in all relay CD-ROADMs 2 on the path connecting the traffic start and end points.

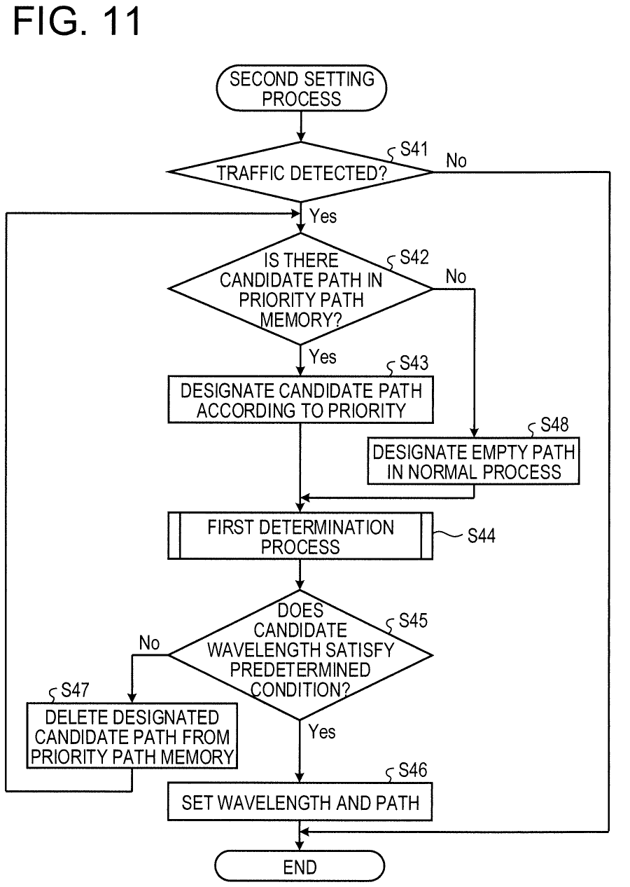

Next, the operation of the optical transmission system 1 of the second embodiment will be described. FIG. 11 is a flowchart illustrating an example of the processing operation of the CPU 24 related to a second setting process. In FIG. 11, the CPU 24 determines whether or not a new traffic is detected in the optical transmission system 1 (Operation S41). When it is determined that a new traffic is detected (“Yes” in Operation S41), the CPU 24 determines whether or not there is a candidate path in the priority path memory 42 (Operation S42).

When it is determined that there is a candidate path in the priority path memory 42 (“Yes” in Operation S42), the CPU 24 designates a candidate path according to a priority (Operation S43). The CPU 24 executes the first determination process with the designated candidate path (Operation S44). The third determination unit 55 in the CPU 24 determines whether or not the candidate wavelength determined in the first determination process satisfies a predetermined condition (Operation S45). When it is determined that the candidate wavelength determined in the first determination process satisfies the predetermined condition (“Yes” in Operation S45), the setting unit 54 in the CPU 24 sets the candidate wavelength and the candidate path as through-target wavelength and path in the relay CD-ROADM 2, respectively (Operation S46). Then, the setting unit 54 ends the processing operation shown in FIG. 11.

When it is determined that the candidate wavelength determined in the first determination process does not satisfy the predetermined condition (“No” in Operation S45), the third determination unit 55 deletes the designated candidate path from the priority path memory 42 (Operation S47). Then, the third determination unit 55 proceeds to Operation S42 to determine whether or not there is a candidate path in the priority path memory 42.

When it is determined that no new traffic is detected (“No” in Operation S41), the CPU 24 ends the processing operation shown in FIG. 11. When it is determined that there is no candidate path in the priority path memory 42 (“No” in Operation S42), the CPU 24 designates an empty path in the normal process (Operation S48) and proceeds to Operation S44 to execute the first determination process.

When a new traffic is detected, the CPU 24 executing the second setting process designates a candidate path corresponding to the new traffic according to a priority. The CPU 24 designates a through-target candidate wavelength in the relay CD-ROADM 2 on the designated candidate path. When the designated candidate wavelength satisfies a predetermined condition, the CPU determines the candidate wavelength as a through-target allocated wavelength. As a result, it is possible to place an optimal optical path for the new traffic.

When the designated candidate wavelength does not satisfy the predetermined condition, the CPU 24 designates a new candidate path and then designates a candidate wavelength in the relay CD-ROADM 2 on the designated candidate path. As a result, it is possible to select a candidate wavelength satisfying the predetermined condition from a plurality of candidate paths.

When the candidate wavelength on the new traffic candidate path satisfies the predetermined condition, the CPU 24 of the second embodiment determines a candidate wavelength in the relay CD-ROADM 2 on the candidate path as a new traffic through-target wavelength. As a result, the CPU 24 can reduce the chance of irregular wavelength placement due to contention avoidance while reducing the number of wavelengths to be contended and suppress wavelength fragmentation, thereby achieving the high utilization efficiency of wavelength resources.

When the candidate wavelength on the candidate path does not satisfy the predetermined condition, the CPU 24 designates another candidate path according to the priority. When the designated candidate wavelength is a wavelength that is usable in the CD-ROADM 2 at the traffic start and end points, the CPU 24 determines the candidate wavelength as a through-target wavelength. As a result, the CPU 24 can flexibly designate a candidate wavelength from a plurality of candidate paths.

When the candidate wavelength is not a wavelength that is usable in the CD-ROADM 2 at the start and end points, the CPU 24 designates another candidate path as the traffic path and then designates a relay CD-ROADM 2 on the designated candidate path. As a result, it is possible to designate a candidate wavelength according to the traffic candidate path.

In the second embodiment, the predetermined condition is that a candidate wavelength is a wavelength being used by all relay CD-ROADMs 2 on a path connecting the traffic start and end points. However, the predetermined condition is not limited thereto but may be changed as appropriate. For example, the predetermined condition may be that a candidate wavelength is a wavelength that is being most frequently used at the present time among wavelengths being used of the relay CD-ROADM 2 on the path connecting the traffic start and end points.

In the first and second embodiments, a candidate wavelength is designated from the wavelengths being used in the relay CD-ROADM 2, but the designation is not limited thereto but may be changed as appropriate. For example, a candidate wavelength may be designated from the wavelengths being used for each optical coupler 13 in the relay CD-ROADM 2, which will be described below as a third embodiment.

### Third Embodiment

Since a WSS 11 of the present embodiment has N output ports, up to N optical components such as optical splitters 12 and optical couplers 13e may be connected. In addition, when the optical components are different, the same wavelength may be optically inserted and branched, thereby allowing contention of N same wavelengths. Therefore, a SDN controller 3B of the third embodiment recognizes the usage of a wavelength for each optical component in the relay CD-ROADM 2 and designates a candidate wavelength from the wavelength usage for each optical component.

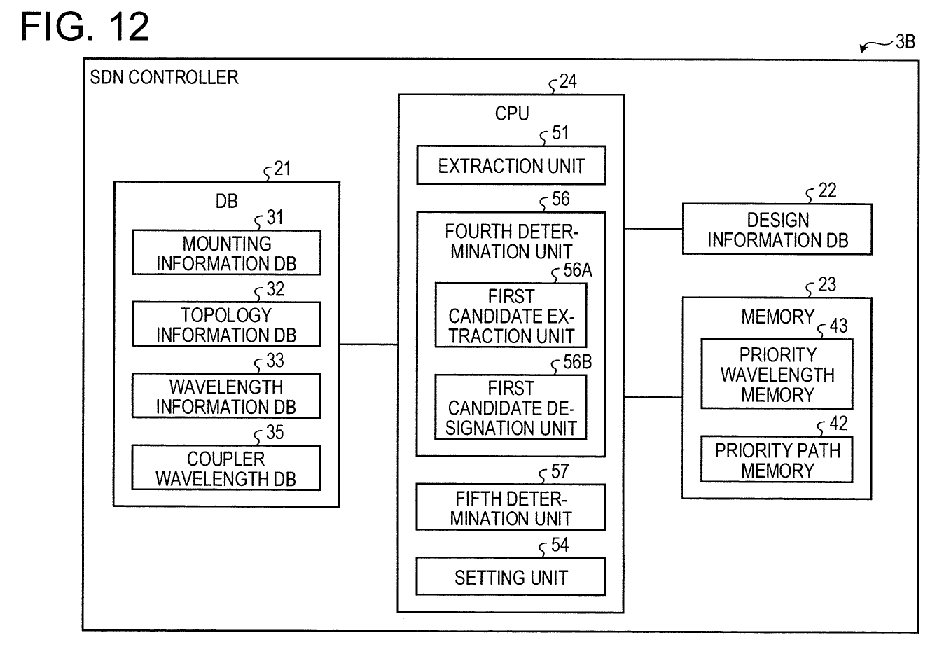

FIG. 12 is an explanatory view illustrating an exemplary functional configuration of the SDN controller 3B according to the third embodiment. In FIG. 12, the same elements and operations as those of the optical transmission system 1 of the first embodiment are denoted by the same reference numerals and therefore, explanation of which will not be repeated. The CPU 24 in the SDN controller 3B includes a fourth determination unit 56 and a fifth determination unit 57 in addition to the extraction unit 51 and the setting unit 54. The fourth determination unit 56 designates a through-target candidate wavelength based on a wavelength being used in an optical coupler 13 in a relay CD-ROADM 2 on a candidate path of a new traffic. The fourth determination unit 56 includes a first candidate extraction unit 56A and a first candidate designation unit 56B. The first candidate extraction unit 56A extracts a wavelength being used for each optical coupler 13 in the relay CD-ROADM 2 and stores the extracted wavelength being used in the coupler wavelength DB 35 for each optical coupler 13. Furthermore, the first candidate extraction unit 56A refers to the coupler wavelength DB 35 to count the use frequency of the wavelength being used in the relay CD-ROADM 2. The use frequency used herein refers to the number of optical components currently using the same wavelength in the relay CD-ROADM 2. The first candidate extraction unit 56A gives priorities to candidate wavelengths based on the use frequency for each wavelength being used and stores the candidate wavelengths in the priority wavelength memory 43. The first candidate designation unit 56B designates a candidate wavelength in the order of higher priority in the priority wavelength memory 43.

The fifth determination unit 57 refers to the wavelength information DB 33 to determine whether or not the designated candidate wavelength is a wavelength that is usable in the CD-ROADM 2 at the traffic start and end points. When the designated candidate wavelength is a wavelength that is usable in the CD-ROADM 2 at the traffic start and end points, the fifth determination unit 57 determines the candidate wavelength as an allocated wavelength. When the designated candidate wavelength is not a wavelength that is usable in the CD-ROADM 2 at the traffic start and end points, the fifth determination unit 57 designates the next candidate wavelength in the fourth determination unit 56.

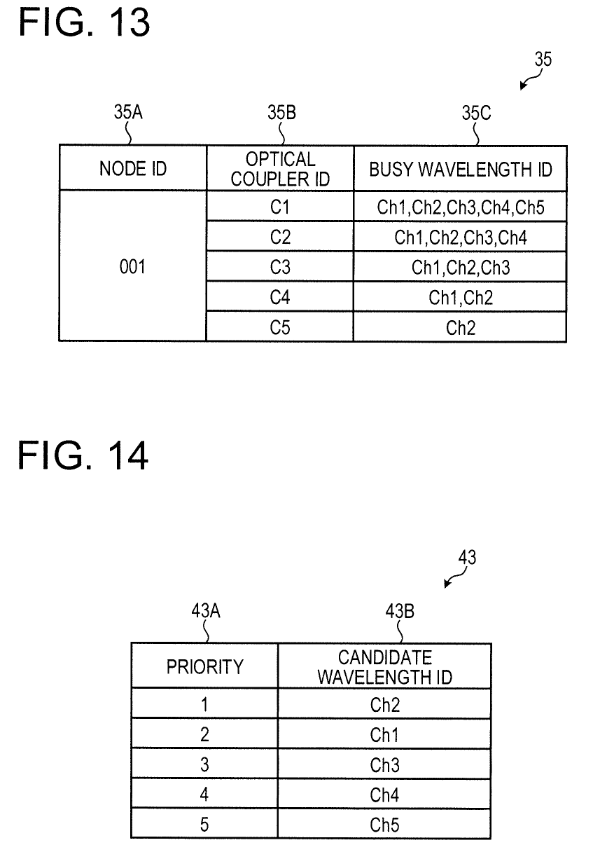

FIG. 13 is an explanatory view illustrating an example of the coupler wavelength DB 35. The coupler wavelength DB 35 shown in FIG. 13 manages a node ID 35A, an optical coupler ID 35B and a busy wavelength ID 35C in association. The node ID 35A is an ID for identifying a relay CD-ROADM 2. The optical coupler ID 35B is an ID for identifying an optical coupler 13 in the relay CD-ROADM 2. The busy wavelength ID 35C is an ID for identifying a wavelength being used in the optical coupler 13 in the relay CD-ROADM 2. The coupler wavelength DB 35 shown in FIG. 13 manages, for example, wavelengths being used Ch1, Ch2, Ch3, Ch4, and Ch5 of an optical coupler Cl in the relay CD-ROADM 2, wavelengths being used Ch1, Ch2, Ch3, and Ch4 of an optical coupler C2, wavelengths being used Ch1, Ch2, and Ch3 of an optical coupler C3, wavelengths being used Ch1 and Ch2 of an optical coupler C4, and a wavelength being used Ch2 of an optical coupler C5. The CPU 24 refers to the coupler wavelength DB 35 to count the use frequency of the wavelength Ch2 five times, the use frequency of the wavelength Ch1 four times, the use frequency of the wavelength Ch3 three times, the use frequency of the wavelength Ch4 twice, and the use frequency of the wavelength Ch5 once.

FIG. 14 is an explanatory view illustrating an example of the priority wavelength memory 43. The priority wavelength memory 43 shown in FIG. 14 manages a priority 43A and a candidate wavelength ID 43B in association. The priority 43A becomes higher as the use frequency of a wavelength being used in the CD-ROADM 2 increases. The candidate wavelength ID 43B is an ID for identifying a candidate wavelength. The CPU 24 refers to the priority wavelength memory 43 shown in FIG. 14 to designate, for example, a wavelength of the first rank Ch2 as a candidate wavelength according to the priority.

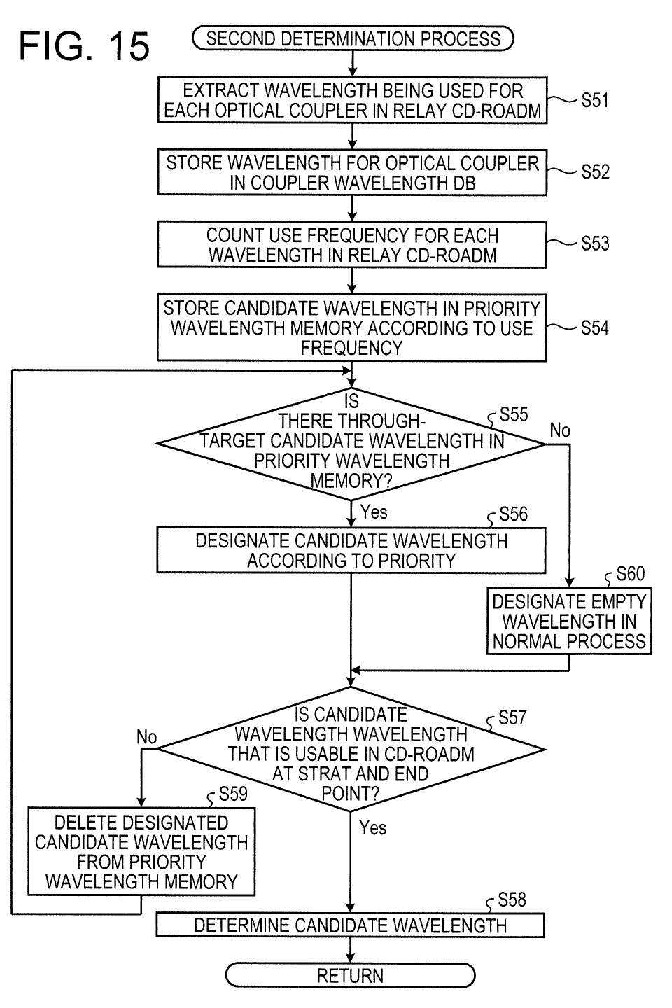

Next, the operation of the optical transmission system 1 of the third embodiment will be described. FIG. 15 is a flowchart illustrating an example of the processing operation of the CPU 24 related to the second determination process. In FIG. 15, the first candidate extraction unit 56A in the CPU 24 extracts a wavelength being used for each optical coupler 13 in the relay CD-ROADM 2 (Operation S51). The first candidate extraction unit 56A stores the extracted wavelength being used for each optical coupler 13 in the coupler wavelength DB 35 (Operation S52).

The first candidate extraction unit 56A counts the use frequency for each wavelength being used in the relay CD-ROADM 2 (Operation S53) and stores a candidate wavelength in the priority wavelength memory 43 according to the use frequency (Operation S54). The first candidate extraction unit 56A determines whether or not there is a through-target candidate wavelength in the priority wavelength memory 43 (Operation S55). When it is determined that there is a through-target candidate wavelength in the priority wavelength memory 43 (“Yes” in Operation S55), the first candidate designation unit 56B in the CPU 24 designates the candidate wavelength according to the priority (Operation S56).

The first candidate designation unit 56B determines whether or not the designated candidate wavelength is a wavelength that is usable in the CD-ROADM 2 at the traffic start and end points (Operation S57). When it is determined that the designated candidate wavelength is a wavelength that is usable in the CD-ROADM 2 at the traffic start and end points (“Yes” in Operation S57), the first candidate designation unit 56B determines the candidate wavelength (Operation S58) and ends the processing operation as shown in FIG. 15.

When it is determined that the designated candidate wavelength is not a wavelength that is usable in the CD-ROADM 2 at the traffic start and end points (“No” in Operation S57), the first candidate designation unit 56B deletes the designated candidate wavelength from the priority wavelength memory 43 (Operation S59). The first candidate designation unit 56B proceeds to Operation S55 to determine whether or not there is a through-target candidate wavelength in the priority wavelength memory 43. When it is determined that there is no through-target candidate wavelength in the priority wavelength memory 43 (“No” in Operation S55), the first candidate designation unit 56B designates an empty wavelength in the normal process (Operation S60). The first candidate designation unit 56B proceeds to Operation S57 to determine whether or not the designated candidate wavelength is a wavelength that is usable in the CD-ROADM 2 at the traffic start and end points.

The CPU 24 that executes the second determination process gives priorities to candidate wavelengths based on the use frequency of a wavelength being used for optical coupler 13 in the relay CD-ROADM 2 on a candidate path connecting the start and end points of the new traffic and stores the candidate wavelengths in the priority wavelength memory 43. The CPU 24 refers to the priority wavelength memory 43 to designate a candidate wavelength according to a priority. When the designated candidate wavelength is a wavelength that is usable in the CD-ROADM 2 at the traffic start and end points, the CPU 24 sets the candidate wavelength as a through-target wavelength. As a result, the CPU 24 can determine an optimal through-target allocated wavelength and allocated path to be used for a new traffic by remote operation. Furthermore, the CPU 24 can reduce the chance of irregular wavelength placement due to contention avoidance while reducing the number of wavelength to be contended and suppress wavelength fragmentation, thereby achieving the high utilization efficiency of wavelength resources. Moreover, by considering the number of optical couplers 13 in the CD-ROADM 2, it is possible to achieve wavelength displacement with high flexibility.

When the designated candidate wavelength is not a wavelength that is usable in the CD-ROADM 2 at the traffic start and end points, the CPU 24 deletes the candidate wavelength from the priority wavelength memory 43 and designates the next rank candidate wavelength from the priority wavelength memory 43. Then, when the designated next rank candidate wavelength is a wavelength that is usable in the CD-ROADM 2 at the traffic start and end points, the CPU 24 determines the candidate wavelength as a through wavelength.

The CPU 24 of the third embodiment refers to the priority wavelength memory 43 to designate a candidate wavelength according to a priority. When the designated candidate wavelength is a wavelength that is usable in the CD-ROADM 2 at the traffic start and end points, the CPU 24 determines the candidate wavelength as a through-target wavelength. As a result, the CPU 24 can determine an optimal through-target allocated wavelength and allocated path to be used for a new traffic by remote operation. Furthermore, the CPU 24 can reduce the number of wavelengths to be contended while reducing the chance of irregular wavelength placement due to contention avoidance and suppress wavelength fragmentation, thereby achieving the high utilization efficiency of wavelength resources.

The CPU 24 designates a transmittable candidate wavelength from wavelengths being used for each optical component that branches, inserts or transmits an optical signal in the relay CD-ROADM 2. As a result, it is possible to designate a candidate wavelength in consideration of optical components in the relay CD-ROADM 2.

The CPU 24 designates a transmittable candidate wavelength from wavelengths being used, based on the use frequency of a wavelength being used for each optical component in the relay CD-ROADM 2. As a result, since a candidate wavelength with the high use frequency in the relay CD-ROADM 2 is designated, it is possible to reduce the number of wavelengths to be contended while reducing the chance of irregular wavelength placement due to contention avoidance and suppress wavelength fragmentation, thereby achieving the high utilization efficiency of wavelength resources.

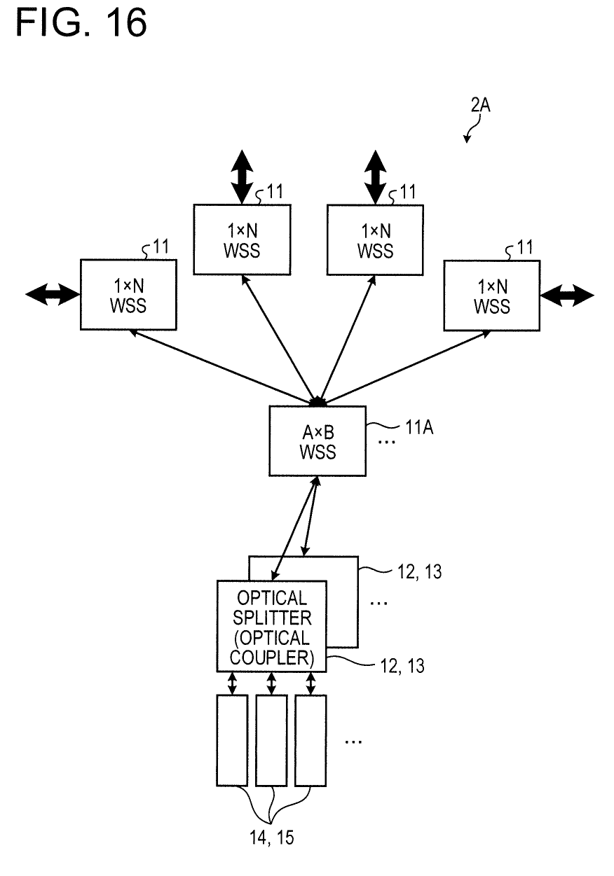

In the present embodiment, the CD-ROADM 2 shown in FIG. 2 is exemplified. However, the present disclosure is not limited thereto but may be changed as appropriate. For example, a CD-ROADM 2A may cope with a network having 10 or more directions. FIG. 16 is an explanatory view illustrating an exemplary hardware configuration of another CD-ROADM 2A.

The CD-ROADM 2A shown in FIG. 16 includes a plurality of WSSs 11, a plurality of optical splitters 12 and optical couplers 13 and a WSS 11A. Each of the WSSs 11 is a wavelength selective switch corresponding to one input port×N output ports. The WSS 11A is a wavelength selective switch corresponding to A input ports×B output ports. The WSS 11A switches and connects A WSSs 11 and optical components such as B optical splitters 12 and optical couplers 13 on a wavelength basis. In this case, the WSS 11A may not use the same wavelength for optical insertion and optical branching, which may lead to serious voidance of contention. In the first embodiment, a candidate wavelength is specified from wavelengths being used in the relay CD-ROADM 2 on a candidate path of a new traffic and the optical components in the CD-ROADM 2 is a factor of contention. In contrast, in the CD-ROADM 2A, since the WSS 11A is a factor of contention, it may be applied to the CD-ROADM 2A by replacing the optical components with the WSS 11A. For example, the SDN controller 3 extracts a wavelength being used for each direction in the WSS 11A and stores a candidate wavelength for each through-direction from wavelengths being used for each direction in the candidate wavelength memory 41. The SDN controller 3 designates a candidate wavelength for each through-direction of the WSS 11A and determines whether or not the designated candidate wavelength is a wavelength that is usable in the CD-ROADM 2 at the traffic start and end points. When the designated candidate wavelength is a wavelength that is usable in the CD-ROADM 2 at the traffic start and end points, the SDN controller 3 sets the candidate wavelength as an allocated wavelength of a traffic passing through the WSS 11A. As a result, even when the CD-ROADM 2A is adopted, it possible to achieve the high utilization efficiency of wavelength resources.

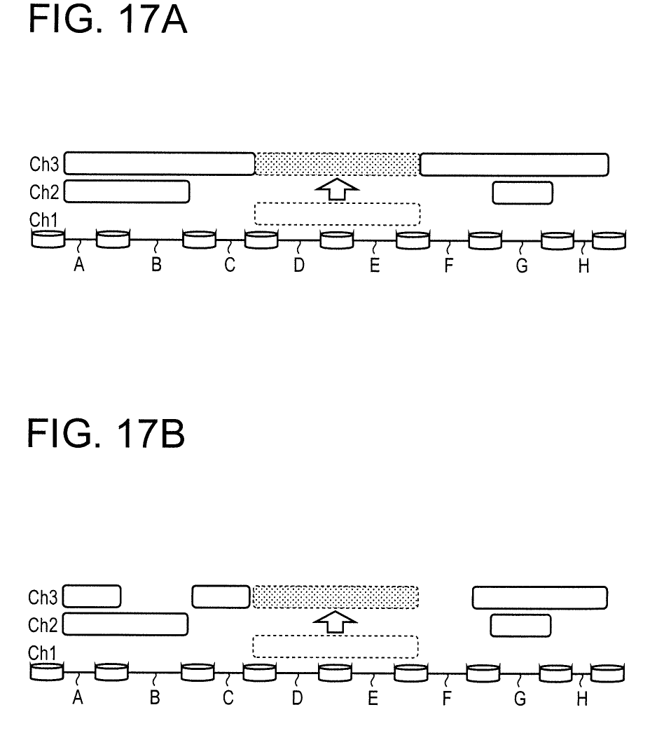

In the first to third embodiments, wavelengths are filled and arranged from the shortest wavelength in order to suppress wavelength fragmentation. However, the present disclosure is not limited thereto. For example, wavelengths may be preferentially filled from a wavelength with high utilization in the optical transmission system 1 and may be changed as appropriate. FIGS. 17A and 17B are explanatory views illustrating an example of a wavelength allocation method of an optical transmission system 1 according to another embodiment.

In the optical transmission system 1 of the wavelength allocation method of FIG. 17A, it is assumed that spans A to H are provided and wavelengths Ch1, Ch2, and Ch3 are being used in the spans D and E, the spans A, B and G and the spans A to C and F to H, respectively. The SDN controller 3 (3A, 3B) has the highest utilization of the wavelength Ch3 and the lowest utilization of the wavelength Ch1. The SDN controller 3 (3A, 3B) changes the wavelength Ch1 of the spans D and E to the wavelength Ch3. As a result, wavelength fragmentation may be suppressed by filling wavelengths continuously to a wavelength with high utilization, thereby achieving the high utilization efficiency of wavelength resources.

In the optical transmission system 1 of the wavelength allocation method of FIG. 17B, it is assumed that wavelengths Ch1, Ch2, and Ch3 are being used in the spans D and E, the spans A, B, and G and the spans A, C, G, and H, respectively. It is assumed that the utilization of the wavelength Ch3 is the highest and the utilization of the wavelength Ch1 is the lowest. The SDN controller 3 (3A, 3B) changes the wavelength Ch1 of the spans D and E to the wavelength Ch3. As a result, even when wavelengths with high utilization are not continuously buried, wavelength fragmentation may be suppressed by filling wavelengths continuously to the wavelengths with high utilization, thereby achieving the high utilization efficiency of wavelength resources.

Although it is not difficult for the SDN controller 3 (3A, 3B) to monitor the use situations of the wavelengths of all the paths in the optical transmission system 1, it is burdensome to monitor the utilization of wavelengths in a wide range of paths within the optical transmission system 1. Therefore, the SDN controller 3 (3A, 3B) may specify an arbitrary monitoring target range in the optical transmission system 1 according to a designated operation, monitor the utilization of wavelengths of the respective paths within the monitoring target range, and collect a wavelength with the highest utilization among these.

The CD-ROADM 2 of the first embodiment has three directions of the directions D1 to D3, as illustrated in FIG. 4, but is not limited thereto and may be changed as appropriate. The CD-ROADM 2 of the third embodiment has five optical couplers C1 to C5, as illustrated in FIG. 13, but is not limited thereto and may be changed as appropriate.

In the above embodiments, a candidate path is designated according to a priority. However, the present disclosure is not limited thereto. For example, a path on which CD-ROADMs 2 having the same candidate wavelength on the path are arranged may be designated as a candidate path.

In the above embodiments, the SDN controller 3 (3A, 3B) for managing the CD-ROADMs 2 in the optical transmission system 1 has been exemplified. However, for example, these embodiments may be applied to an NMS (Network Management System) and may be changed as appropriate. The SDN controller 3 (3A), for example, is a management device. The optical transmission system 1 is not limited to a mesh configuration but may be applied to, for example, a star type, a linear type or a tour type and may be changed as appropriate.

In addition, constituent elements of the various depicted parts are not necessarily physically configured as illustrated in the drawings. In other words, the specific forms of distribution and integration of the various parts are not limited to those shown in the drawings, but all or some thereof may be distributed or integrated functionally or physically in arbitrary units depending on various loads and use situations.

Furthermore, the various processing functions performed by the respective devices may be entirely or partially executed on a CPU (Central Processing Unit) (or a microcomputer such as an MPU (Micro Processing Unit) or an MCU (Micro Controller Unit)). Further, the various processing functions may be entirely or partially executed on a program that is analyzed and executed by a CPU (or a microcomputer such as an MPU or an MCU) or on hardware using a wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device configured to manage a plurality of optical nodes in an optical transmission system, the management device comprising:
a memory; and
a processor coupled to the memory and the processor configured to:
specify a relay node on a path relaying a traffic in the optical transmission system among the plurality of optical nodes;
designate a candidate wavelength of a candidate for a target of transmitting through the traffic in the specified relay node from wavelengths being used in the specified relay node;
determine whether or not the designated candidate wavelength is usable in an optical node of the plurality of optical nodes to terminate the traffic; and
set the candidate wavelength in the relay node, as a wavelength used to transmit through the traffic, when it is determined that the designated candidate wavelength is usable in the optical node to terminate the traffic.

2. The management device according to claim 1,
wherein the processor is further configured to designate a transmittable candidate wavelength from wavelengths being used in an optical component for branching, inserting, or transmitting an optical signal in the relay node, instead of the wavelength being used in the specified relay node.

3. The management device according to claim 1,
wherein the processor is further configured to designate a path of the traffic as a separate path and specify a relay node to relay the traffic on the designated path, when it is determined that the designated candidate wavelength is unusable in the optical node to terminate the traffic.

4. The management device according to claim 2,
wherein the processor is further configured to designate the transmittable candidate wavelength from the wavelengths being used in the optical component according to a use frequency of wavelengths being used in the optical component in the relay node.

5. The management device according to claim 1,
wherein the processor is further configured to set the candidate wavelength in the relay node, as the wavelength used to transmit through the traffic, when the candidate wavelength is usable in the optical node to terminate the traffic and the candidate wavelength satisfies a predetermined condition.

6. The management device according to claim 1,
wherein the processor is further configured to designate the candidate wavelength in an order of wavelength length from the wavelengths being used in the relay node.

7. The management device according to claim 1,
wherein the processor is further configured to designate the candidate wavelength that is usable for each transmission direction in the relay node from the wavelengths being used in the relay node.

8. A wavelength setting method executed by a processor included in a management device configured to manage a plurality of optical nodes in an optical transmission system, the wavelength setting method comprising:
specifying a relay node on a path relaying a traffic in the optical transmission system among the plurality of optical nodes;
designating a candidate wavelength of a candidate for a target of transmitting through the traffic in the specified relay node from wavelengths being used in the specified relay node;
determining whether or not the designated candidate wavelength is usable in an optical node of the plurality of optical nodes to terminate the traffic; and
setting the candidate wavelength in the relay node, as a wavelength used to transmit through the traffic, when it is determined that the designated candidate wavelength is usable in the optical node to terminate the traffic.
